(19) United States
(12) Patent Application Publication
(10) Pub. No.: US 2012/0073357 A1
(43) Pub. Date: Mar. 29, 2012

(54) Method For Determining Gas Concentrations in a Gas Mixture Based on Thermal Conductivity Measurements With Correction of Measured Values

(75) Inventors: Heinz Gatzmanga, Koethen (DE); Roberto Wolff, Osternienburg (DE); Hermann Stahl, Nidderau-Ostheim (DE)

(73) Assignee: THERMO ELECTRON LED GMBH, Langenselbold (DE)

(21) Appl. No.: 13/231,241

(22) Filed: Sep. 13, 2011

(30) Foreign Application Priority Data
Sep. 29, 2010 (DE) 10 2010 046 829.0

(51) Int. Cl. G01N 25/18

(52) U.S. Cl. 73/25.03

(57) ABSTRACT

A method for the determination of gas concentrations xᵢ in a gas mixture using a thermal conductivity detector with a Wheatstone bridge. It comprises the following method steps: measuring the bridge voltage Xₐ; correcting the measured values for the bridge voltage Xₐ, in particular with respect to drift; determination of the thermal conductivity of the gas mixture; and determination of at least one gas concentration xᵢ. Preferably, an automatic zero-point correction and an automatic measuring range end value correction occur within the framework of the correction.

### CROSS-REFERENCE TO RELATED APPLICATIONS

The present application claims priority under 35 U.S.C. §119 of German Patent Application No. 10 2010 046 829.0, filed on Sep. 29, 2010, the disclosure of which is hereby incorporated herein by reference in its entirety.

### FIELD OF THE INVENTION

The present invention relates to a method for determining gas concentrations in a gas mixture using a thermal conductivity detector with a Wheatstone bridge. The method is especially suitable for use in laboratory environments. It can especially be used in an incubator for the precise determination of gas concentrations in a gas mixture. The present invention further relates to a computer program product with a program code for performing the method for determining gas concentrations in a gas mixture, the use of the method for determining gas concentrations in a gas mixture for characterizing the atmosphere in an incubator and an incubator with a correspondingly adapted gas concentration determination unit.

### BACKGROUND OF THE INVENTION

It has long been known from the state of the art that the composition of a gas mixture can be inferred from the determined thermal conductivity. By approximation, the total thermal conductivity λ(T) in gas mixtures can be represented as follows:

λ(T)=x₁λ₁(T)+x₂λ₂(T)+ . . .

In this respect, xᵢ designates the mol fraction of the gas i. The above approximate formula is, however, insufficient for a more precise determination of the composition of gas mixtures.

A more precise approach is the following approach, according to which the total thermal conductivity λ(T) is a function of the respective thermal conductivities λᵢ(T) of the various gases i, the mol fraction of the gases xᵢ and the corrective factors Φᵢⱼ(T) according to Mason and Saxena, wherein the corrective factors Φᵢⱼ(T) can be determined from the viscosity coefficients ηᵢ(T) and the molar masses Mᵢ of the individual gas components. The following therefore applies:

$$λ ( T ) = {\sum }_{i} \frac{{x}_{i} {λ}_{i} ( T )}{{\sum }_{j} {x}_{j} {φ}_{ij} ( T )}$$

The functions λᵢ(T) and the corrective factors Φᵢⱼ(T) are known. Only the gas concentrations xᵢ are unknown. These can be determined if there is a sufficient corresponding number of value pairs λ(T) present.

Various ways of realizing thermal conductivity detectors are known from the state of the art. A common form of thermal conductivity detector is the thermal conductivity detector with a Wheatstone bridge. Measuring gases and reference gases are provided in separate chambers that are heated by way of integrated heating wires. The wires thus function as a heat source. The walls of the chambers function as a heat sink and are normally kept at a constant temperature level. The discharge of heat or the temperature at the respective heating wires in a chamber depends on the thermal conductivity λ of the gas present in the chamber. The heating wires of the chambers are interconnected in the manner of a Wheatstone circuit. Generally, the Wheatstone bridge is first calibrated. If the conductivity of the measuring gas changes afterwards, because, e.g., the material composition of the gas in the measuring chamber changes or because the temperature of the heating wire has changed, a voltage (bridge voltage) can be tapped between the two branches of the bridge circuit.

A method for determining the gas concentrations in a gas mixture and a sensor for measuring the thermal conductivity are known from DE 37 11 511 C1. The thermal conductivity of the gas mixture with N gas components is measured at N−1 gas temperatures. The individual gas concentrations are calculated from the determined measured values of the thermal conductivity. The sensor disclosed in the patent specification consists of a silicon support plate with etched thin-film resistors on which a cover plate rests. Both plates comprise depressions etched at the level of the thin-film resistors forming the measuring chamber. The gas mixture to be determined has access to the measuring chamber in only one diffusion channel via openings.

WO 01/27604 A1 discloses a method and a device for determining the gas concentrations in a gas mixture. The thermal conductivities of the gas mixture are determined at different temperatures and the individual gas concentrations are determined therefrom. The thermal conductivities are determined in a temperature-time function running periodically between a minimum and a maximum temperature value. The thermal conductivities obtained in the temperature-time progression are determined continuously as a function of time. The time function of thermal conductivity is subjected to a Fourier analysis and the concentrations of the individual gas components are determined from the coefficients of this Fourier analysis.

### SUMMARY OF THE INVENTION

It is the object of the present invention to provide an alternative or improved method for determining gas concentrations in a gas mixture using a thermal conductivity detector with a Wheatstone bridge. In particular, the method shall provide improved measuring precision.

According to a first embodiment, the present invention relates to a method for the determination of gas concentrations xᵢ in a gas mixture using a thermal conductivity detector with a Wheatstone bridge. The gas mixture can be composed of two, three, four or more components. The thermal conductivity detector with a Wheatstone bridge described in the introductory part of the present application is suitable for the purposes of the method according to the present invention. For example, there are two chambers in each of the two branches of the bridge, of which one contains the measuring gas and the other the reference gas. It is alternatively also possible that the chamber with the measuring gas in the one branch of the bridge circuit and the chamber with the reference gas in the other branch of the bridge are replaced by resistors of a known magnitude. The use of two chambers per branch and thus a total of two chambers with measuring gas and two chambers with reference gas allows, however, a simplified evaluation of the values for the bridge voltage Xₐ produced with the help of the arrangement.

According to the method in accordance with the present invention, the bridge voltage Xₐ is measured. This measurement can be performed once or several times. It is possible that several measurements are performed under unchanged parameters or under different parameters—in particular at different temperatures of the heating wires in the chambers—in order to obtain several values for the bridge voltage Xₐ. A correction of the measured values for the bridge voltage Xₐ, in particular with respect to drift, is performed in accordance with the present invention in a further method step. Preferably, all measured values for the bridge voltage Xₐ are corrected, although it is also possible to perform only a single correction of a mean value for the bridge voltage Xₐ. The thermal conductivity of the gas mixture in the measuring cell or measuring cells is determined in a further method step from the determined corrected values and at least one gas concentration xᵢ of the gas mixture is then determined therefrom. Preferably, the concentration of all gas components is determined.

In accordance with a preferred embodiment of the present invention, the bridge voltage xₐ is measured at least two different temperatures T. Preferably, the thermal conductivity of the gas mixture at each of these temperatures is determined in this case. At least one gas concentration xᵢ of the gas mixture is determined from the thus determined thermal conductivity values of the gas mixture, as explained in the introductory part of the present patent application. Preferably, all gas concentrations xᵢ are determined for all substances of the gas mixture.

According to a preferred embodiment of the present invention, the gas mixture comprises two components in the measuring cell, preferably carbon dioxide and water vapor. The thermal conductivity λ(T) of the gas mixture is preferably determined in this case at two different temperatures T. For this purpose, a corresponding bridge voltage xₐ is measured at the two different temperatures T. The measured values for the bridge voltage xₐ are corrected. On this basis, the thermal conductivity of the gas mixture is determined from the two components, and the two gas concentrations x₁ and x₂ as well as x_{CO2} and x_{H2O} vapor are determined.

If the thermal conductivities of the individual gas components contained in the gas mixture differ relatively clearly from one another, then it is principally also possible to draw conclusions regarding a gas concentration for a specific component in the gas mixture on the basis of only one measuring signal for the bridge voltage xₐ. This can occur, e.g., as a result of a signal deformation that can be detected and evaluated by mathematical methods. In a case where the measuring cell contains the two components CO₂ and water vapor, a change in a signal property that is only attributable to a change in the humidity or the water vapor in the measuring gas can be detected irrespective of the CO₂ content.

According to a preferred embodiment of the present invention, the thermal conductivity sensor with the Wheatstone bridge is operated with direct current. It is possible here to vary the intensity of the direct current or modulate the same over time. The operation of the Wheatstone bridge with direct current means that—even in the case of a modulation of the current intensity—the heating wires in the chambers are operated at an essentially constant temperature.

According to a preferred embodiment of the present invention, a change in temperature for determining at least one additional measured value for the thermal conductivity at another temperature occurs by impressing a defined current pulse on the direct current. The total current intensity resulting from the impressed current pulse can be either increased or reduced in comparison with the initial intensity of the direct current applied standardly. If the total current intensity is increased by impressing the current pulse, this leads to an increase in the temperature in the heating wires of the gas chambers, thus enabling a thermal conductivity measurement at higher temperatures. If, on the other hand, a current pulse is impressed on the operating direct current that reduces the total current intensity, then the temperature of the heating wires is decreased and the thermal conductivity of the gas mixture can be determined at this lower temperature.

In accordance with a preferred embodiment of the present invention, the correction of the measured values for the bridge voltage comprises a zero-point correction and/or a measuring range correction. In the case of the zero-point correction, an optionally provided display of the bridge voltage and/or an optionally provided bridge voltage different from zero is corrected in a principally calibrated state of the Wheatstone bridge. Accordingly, the measuring range correction describes a correction of values for the bridge voltage differing from zero. Preferably, the corrections occur automatically, e.g., by computerized means.

In accordance with a preferred embodiment of the present invention, a negative pulse is impressed on the direct current for zero-point correction so that the theoretical bridge voltage becomes zero; subsequently, the actual bridge voltage is measured. By impressing a negative pulse, the total current intensity is reduced to such an extent that there is no longer any temperature gradient between the heating wires forming the heat source for the heat transport through the gas and the heat sink formed by the walls so that heat dissipation by the gas enclosing the heating wires no longer occurs. The bridge voltage measured in such an operating state should theoretically have the value zero entirely irrespective of which gases are in the gas chambers and in which concentration. The actual bridge voltage is measured. If a deviation occurs during this measurement between the actually measured value for the bridge voltage and the theoretically precisely known value (which is zero here), this deviation will be determined and used for self-correction. In the simplest case, the deviation is added as an offset value to the measured bridge signals.

According to a further preferred embodiment of the present invention, a resistor with a known value is connected to a branch of the Wheatstone bridge for the measured value correction, and the bridge voltage is measured with the connected resistor. The connected resistor can be a single resistor or a network of resistors. The important thing is that the magnitude of this resistor is precisely known. Preferably, the connection of the known resistor occurs only after the impression of a negative pulse on the direct current, the intensity of which is calculated in such a way that the value zero results from the theoretically expected bridge voltage. Such a pulse is, e.g., described above with regard to the zero-point correction. The bridge voltage measured thereafter with the connected resistor then depends on the magnitude of the connected resistor alone. This allows a simple and precise calculation of the theoretically expected value for the bridge voltage, which can be compared with the actually measured bridge voltage. If there is a deviation between the measured value for this bridge voltage and the theoretically precisely known value, this deviation is determined and used for self-correction. In the simplest case, this deviation can be added as an offset value to the measured bridge signals.

According to a preferred embodiment of the present invention, at least one of the steps of the method in accordance with the invention as described above in greater detail is performed several times. It goes without saying that it is possible to perform all method steps several times.

According to a preferred embodiment of the present invention, the correction of the measured values for the bridge voltage occurs periodically. This means that the correction occurs at regular intervals over time. For example, such a correction can occur at intervals of minutes, hours, days, weeks or even months, etc. If the correction occurs at longer intervals of time, it is possible to respond appropriately in this way to a potential creeping drift which would only have an effect after a prolonged period of time, in certain circumstances after years.

It is alternatively also possible that the method for self-correction occurs aperiodically. This can be the case, for example, when the ambient environment of the thermal conductivity detector is at the level of carrier gas. Such an aperiodic correction is also highly suitable in particular for the correction of a creeping drift.

According to a preferred embodiment of the present invention, the current pulses impressed on the direct current are rectangular. Alternatively they can be sawtooth-shaped or sinusoidal. Other forms of pulses are principally also possible.

According to a preferred embodiment of the present invention, at least one concentration xᵢ of a substance in the gas mixture is displayed. Such a display, e.g., on a monitor or a simple display, allows continuous monitoring of the material concentration of interest by personnel.

According to a further embodiment, the present invention relates to a computer program product with a program code for performing the method for determining gas concentrations xᵢ in a gas mixture using a thermal conductivity detector with a Wheatstone bridge, as has been described above in greater detail. The computer program product can be, e.g., a CD-ROM or a DVD that contains the program code. It goes without saying that other data media are also possible. The program code can be written in all common programming languages.

In accordance with a preferred embodiment of the present invention, the program code contains an algorithm for zero-point correction and/or an algorithm for measuring range correction. This allows a particularly fast correction of measured values for the bridge voltage; as a result, gas concentrations of the gas mixture can be determined especially quickly and precisely.

In accordance with a further embodiment, the present invention relates to a use of the method in accordance with the present invention for characterizing the atmosphere in an incubator. In particular, the material composition of the atmosphere in the incubator can be determined in a particularly precise and rapid manner.

In accordance with a further embodiment, the present invention relates to an incubator itself. Incubators as such are sufficiently known from the state of the art. Items such as cell cultures or microorganisms are stored in incubators over prolonged periods of time at an increased temperature, often at a very high humidity and in some cases in an atmosphere enriched with carbon dioxide. Incubators are standardly equipped with a heating unit and with a control unit for temperature control. They frequently also comprise a humidifier unit and/or an external gas connection to an atmospheric source that can contain, e.g., carbon dioxide. The interior space of the incubator is the inside area of the incubator that is subject to fixed or adjustable environmental parameters. The interior space of the incubator contains an approximately homogeneous atmosphere with an approximately homogeneous composition. Furthermore, essentially the same temperature reigns in the interior of the incubator. In accordance with the present invention, the incubator has a gas concentration determination unit that is set up to work according to the method for determining gas concentrations in a gas mixture, said method using a thermal conductivity detector with a Wheatstone bridge, as has been described above. In particular, the gas concentration determination unit also comprises means in order to correct the measured values for the bridge voltage of the Wheatstone bridge. Preferably, such a correction automatically occurs by means of a processor unit or a computer.

In accordance with a preferred embodiment, the incubator also comprises an atmospheric control unit that is set up in so that the percentage of the gases present in the atmosphere of the incubator can be varied. It is thus possible to respond actively to, e.g., a specific material composition of the atmosphere that is determined by means of the gas concentration determination unit. If there is a deviation from desired reference values, a gas component of which there is an excess can be reduced or a component present in the gas mixture in an insufficient concentration can be increased by providing additional gas.

### BRIEF DESCRIPTION OF THE DRAWINGS

The present invention is understood even better under reference to the enclosed drawings, of which:

FIGS. 1a and 1b show a circuit diagram and the relevant current pulses for operating a thermal conductivity detector with Wheatstone bridge, and

FIGS. 2a and 2b show a circuit diagram and the relevant current pulses for a zero-point and a measuring range correction of a thermal conductivity detector with a Wheatstone bridge in accordance with the present invention.

### DETAILED DESCRIPTION

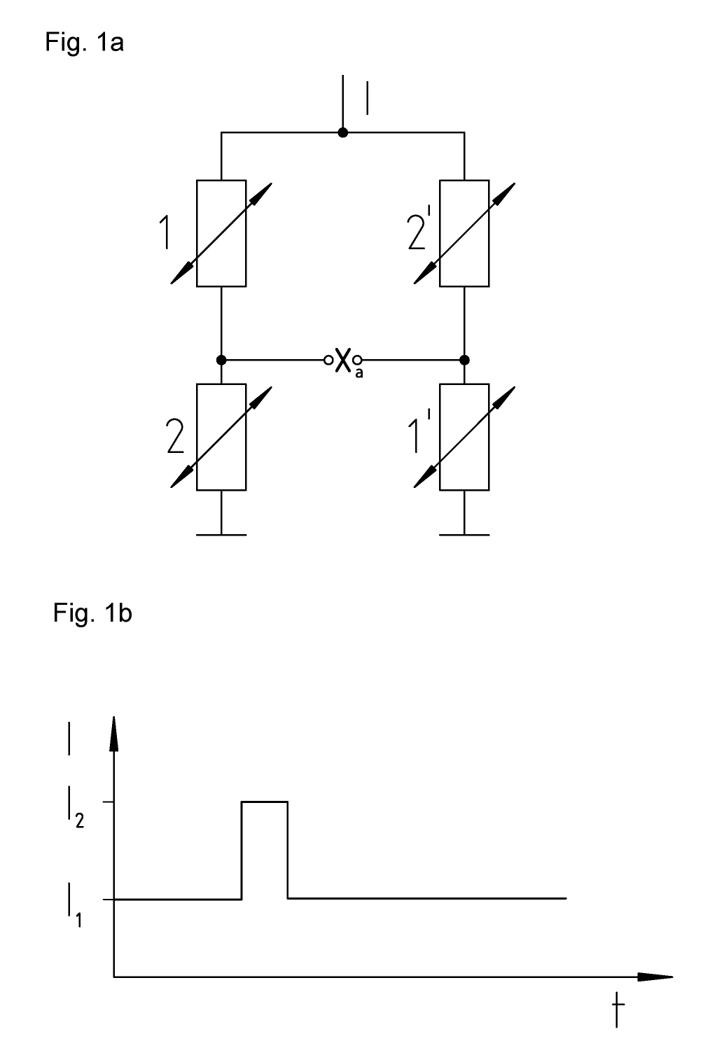

FIG. 1a shows a circuit diagram for operating a thermal conductivity detector with a Wheatstone bridge. A total of four chambers with gas are shown, chambers 1 and 1′ designating chambers with measuring gas and chambers 2 and 2′ designating chambers with the known reference or carrier gas. There is thus one cell with measuring gas and one cell with the known reference or carrier gas in each branch of the bridge (to the left and right in FIG. 1a). The bridge voltage Xₐ is tapped between the two branches of the bridge. It is possible to infer the thermal conductivity of the measuring gas in the measuring chambers 1 and 1′ from the measured bridge voltage Xₐ. In turn, the thermal conductivity depends on the material composition of the gas mixture in the measuring chambers and thus also on the concentrations of the individual gases and the temperature. The temperature can be set by way of the intensity of the current flowing through the heating wires in the gas chambers. The four heating wires in the four gas chambers here are essentially equally warm.

FIG. 1b illustrates the intensity of the current for operating the thermal conductivity detector with a Wheatstone bridge. The thermal conductivity detector is principally operated with direct current of an intensity I₁. However, a defined current pulse is impressed temporarily on the direct current. In the illustrated example, the impressed pulse is rectangular and leads to a temporally limited increase in the intensity of the current to the value I₂. This leads to a change in the temperature of the heating wires in the gas chambers. The heat dissipation in the heating wires thus changes and another value is measured as the bridge voltage Xₐ, which must be matched with a different thermal conductivity of the gas mixture that depends on the temperature.

According to an embodiment of the present invention, illustrated here as an example, air which is locked tightly in the reference cells 2 and 2′ is chosen as the carrier or reference gas. Carbon dioxide and water vapor are chosen by way of example as the measuring gas mixture, which flows around the heating wires provided in the chambers 1 and 1′. The thermal conductivity of air is standardly set at 1 and the thermal conductivities of gases relative to air are indicated. For example, the relative thermal conductivity of carbon dioxide is 0.71 at 100° C. for and 0.78 at 200° C. The thermal conductivity of water vapor is 0.78 at 100° C. and 0.86 at 200° C.

In order to determine the gas concentrations of carbon dioxide or water vapor, a first value can be obtained for the bridge voltage Xₐ at a temperature of 100° C. and a second value is determined after an increase in the intensity of the current from I₁ to I₂ at a temperature of 200° C. It is now possible to infer in the known manner the concentration of both the carbon dioxide and the water vapor from the known properties of the gases and the measured values.

It is alternatively also possible to detect a representation of different water vapor concentrations in the measuring signal, e.g., by a signal deformation that can be determined with mathematical methods. Ideally, a change in a signal property that is only attributable to a change in the humidity in the measuring gas can be detected irrespective of the carbon dioxide content.

The different thermal conductivities of carbon dioxide, on the one hand, and water vapor, on the other hand, lead to a signal whose predominant cause is carbon dioxide and only to a lesser extent water vapor. As a result of a pulsed increase in the direct current on the Wheatstone bridge, a measuring signal is obtained in the Wheatstone bridge that is caused predominantly by water vapor. An algorithm for evaluating these differences will then lead to the determination of the respective concentrations of carbon dioxide and water vapor.

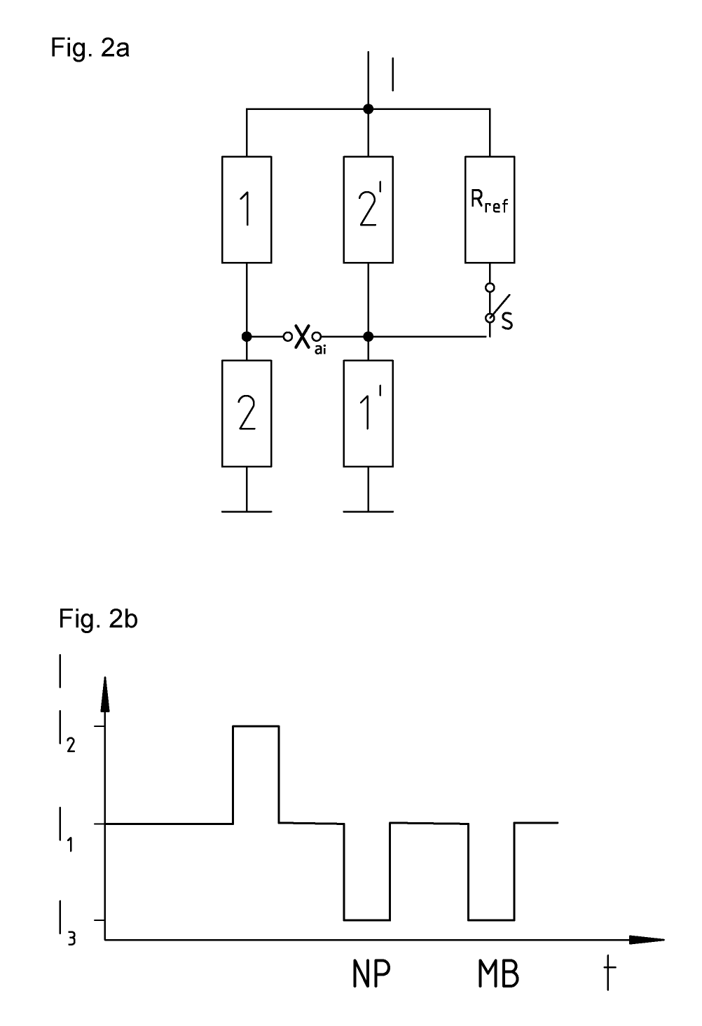

FIGS. 2a and 2b show a circuit diagram and corresponding current pulses for the zero-point and measuring range correction of a thermal conductivity detector with Wheatstone bridge in accordance with the present invention. FIG. 2a illustrates the connection of a known resistor R_{ref} to the circuit diagram of the gas chambers with carrier and measuring gases shown in FIG. 1a. The temporary connection of the known resistor R_{ref} occurs by closing a switch S. The resistor R_{ref} can be a single resistor or a resistor network. Decisive here is the most precise knowledge possible of the magnitude of the resistor R_{ref}.

FIG. 2b shows the current pulses for zero-point and measuring range correction. Direct current with an intensity Iᵢ is standardly applied to the thermal conductivity detector. It is briefly increased in a pulsed manner to the current intensity I₂, whereby it is possible to obtain an additional measured value of the bridge voltage Xₐ for a changed temperature T, as has already been explained in detail with respect to FIG. 1. Switch S is open during this entire process. A negative pulse is then impressed onto the direct current for the zero-point correction NP so that a total current intensity I₃ is obtained. At this total current intensity I₃, the theoretical bridge voltage Xₐ is zero, i.e., the temperature of the heating wires has decreased to such an extent that there is no longer any temperature gradient between the heat source, i.e., the heating wires in the measuring chambers, and the heat sink, i.e., the walls of the gas chambers. There is no longer any heat transport through the gases present in the chambers. The bridge voltage Xₐ is then determined and it is established whether or not there is any deviation from the theoretical value of zero. If this is the case, the determined deviation will be used for self-correction and, in the simplest case, is added as an offset value to the measured bridge signals within the framework of the determination of thermal conductivity.

A measuring range correction MB occurs a little later in the illustrated example. For this purpose, a negative pulse is impressed on the direct current this time in such a way that the theoretical bridge voltage becomes zero. This time, however, switch S is closed and the value Xₐ tapped as the bridge voltage is entirely dependent on the known value of the resistor R_{ref}. The theoretically precisely known value is compared with the actually determined value of the bridge voltage. If a deviation is determined, it is used for self-correction. In the simplest case, the deviation is added as an offset value to the measured bridge signals.

In the example illustrated in FIG. 2b the zero-point correction NP and the measuring range correction MB occur at an interval with respect to one other. It goes without saying that is also possible to perform one correction directly after the other. To do this, it is merely necessary to close the switch S after the measurement of the bridge voltage in a theoretically calibrated state of the bridge circuit in order to connect the known resistor R_{ref}.

In a practical embodiment, the deviations determined in the zero-point correction and the measuring range correction are saved internally in a memory area of a processor. The calculation then occurs in a software routine, preferably both via an algorithm for a zero-point correction as well as via an algorithm for the correction of the measuring range end value. In the simplest case of correction, the deviation can be considered as an offset value by summation to the measured bridge signal.

The method in accordance with the present invention can be used in an incubator, for example, by allowing the determination of the material composition of the atmosphere within the incubator by means of a correspondingly adapted gas concentration determination unit. As a result, a highly precise and simple determination of the material composition of the atmosphere in the incubator that can also be monitored and controlled in a simple way is possible.

While the present invention has been illustrated by description of various embodiments and while those embodiments have been described in considerable detail, it is not the intention of Applicants to restrict or in any way limit the scope of the appended claims to such details. Additional advantages and modifications will readily appear to those skilled in the art. The invention in its broader aspects is therefore not limited to the specific details and illustrative examples shown and described. Accordingly, departures may be made from such details without departing from the spirit or scope of Applicants' invention.

What is claimed is:

1. A method for determining gas concentrations xᵢ in a gas mixture using a thermal conductivity detector with a Wheatstone bridge, comprising:
measuring a bridge voltage xₐ;
correcting the measured values for the bridge voltage xₐ with respect to drift;
determining the thermal conductivity of the gas mixture; and
determining at least one gas concentration xᵢ.

2. A method according to claim 1, wherein the bridge voltage xₐ is measured at least two different temperatures T.

3. A method according to claim 2, wherein the thermal conductivity detector with the Wheatstone bridge is operated with direct current.

4. A method according to claim 3, wherein a temperature change for determining at least one additional measured value for the thermal conductivity occurs by impressing a defined current pulse on the direct current.

5. A method according to 4, wherein the correction comprises a zero-point correction and/or a measuring range correction.

6. A method according to claim 5, wherein a negative pulse is impressed on the direct current for zero-point correction in such a way that the theoretical bridge voltage becomes zero and the actual bridge voltage is measured.

7. A method according to claim 5, wherein a known resistor is connected to a branch of the Wheatstone bridge for measured value correction and the bridge voltage is measured with a connected resistor.

8. A method according to claim 6, wherein a deviation between the actually measured value for the bridge voltage and the theoretically precisely known value is determined and used for self-correction.

9. A method according to claim 8, wherein a deviation is added as an offset value to measured bridge signals.

10. A method according to claim 1, wherein at least one of the method steps is performed several times.

11. A method according to claim 1, wherein the correction occurs periodically.

12. A method according to claim 4, wherein the pulses impressed on the direct current are rectangular, sawtooth-shaped or sinusoidal.

13. A method according to claim 1, wherein at least one concentration xᵢ of a substance in the gas mixture is displayed.

14. A method according to claim 1, wherein the gas mixture comprises CO₂ and water vapor.

15. A method according to claim 14, comprising an algorithm for zero-point correction and/or an algorithm for measuring range correction.

16. A computer program product with a program code for performing the method according to claim 1.

17. The use of the method according to claim 1 for characterizing the atmosphere in an incubator.

18. An incubator with a gas concentration determination unit set up to work according to claim 1.

19. An incubator according to claim 18, comprising an atmospheric control unit which is set up so that a percentage of the gases present in the atmosphere of the incubator can be varied.

20. A method according to claim 7, wherein a deviation between the actually measured value for the bridge voltage and the theoretically precisely known value is determined and used for self-correction.

21. A method according to claim 20, wherein a deviation is added as an offset value to measured bridge signals.
